(19) United States
(12) Patent Application Publication
(10) Pub. No.: US 2005/0015491 A1
(43) Pub. Date: Jan. 20, 2005

(54) Systems, methods, and articles of manufacture for dynamically providing web services

(75) Inventor: Arthur Koeppel, Richmond, VA (US)

Correspondence Address: Finnegan, Henderson, Farabow,;Garrettt & Dunner, L.L.P., 1300 I Street, N.W., Washington, DC, 20005-3315, US

(73) Assignee: Markel Corporation

(21) Appl. No.: 10/438,916

(22) Filed: May 16, 2003

(51) Int. Cl. G06F 15/173; G06F 15/16

(52) U.S. Cl. 709/226; 709/225; 709/229

(57) ABSTRACT

Methods, systems, and articles of manufacture are disclosed for dynamically providing web services in a distributed system. In one embodiment, a distribution server uses a generic interface to invoke any one of a plurality of web services based on a user request at a client system. The distribution server provides content information that a client system uses to display a customized web page for an authorized user. When the user selects content on a customized web page associated with a web service, the client's system sets data values in one or more hidden fields and provides the fields to the distribution server. The server passes the field information to the selected web service to produce result data. The distribution server may use the result data and collected format data to generate the content information that is used to generate the customized web page for the authorized user. Embodiments of the present invention enable the distributed system to modify a web service without having to reprogram any consumers of the modified web service. Further, the distribution server is configured such that it dynamically and automatically determines any web services that a user may access and provides access to the authorized web services through the generic interface.

### BACKGROUND OF THE INVENTION

I. Field of the Invention

The present invention generally relates to distributed systems that implement web services and, more particularly, relates to systems, methods, and articles of manufacture for dynamically configuring web services in a distributed system.

II. Background and Material Information

The Internet has become a ubiquitous tool in today's business environments. Businesses strive not only to use the Internet to increase market share by soliciting customers world-wide, but also they are continuously seeking ways to increase the efficiency of inter-business transactions through the Internet. One feature of the Internet that is helping businesses realize this efficiency is web services, such as those offered by the .NET® web services architecture from Microsoft®.

The .NET web service architecture associate web services with technologies that integrate business processes and services over the Internet. A web service allows computing systems to access distributed software components through standard web protocols, such as the Hyper Text Transfer Protocol (HTTP) and Simple Object Access Protocol (SOAP). Computing systems use the Internet and extensible Markup Language (XML) to generate these software components that communicate with other software components, regardless of platform or software language. Because computing systems may design their own interface protocols, the integration between different computing system components can be difficult and costly. To handle these difficulties, computing systems now invoke web services by substituting the Internet for their customized interface protocols and implementing standardized protocols, such as Simple Object Access Protocol (SOAP), to help create software that is reusable and compatible with different types of computing systems.

Web services may be described using the Web Services Description Language (WSDL). A WSDL file includes definitions for a web service's requests and responses, including the schemas needed to create the requests and response. Web services may be published in a registry using Universal Description, Discovery, and Integration (UDDI) and are invoked using HTTP using SOAP protocols. A UDDI registry allows businesses to publish their web services and locate other web services published by other businesses. Using UDDI Application Programming Interfaces (APIs), businesses may locate a service that matches their requested criteria, such as retrieving the best price on a product or service offered by another business.

Distributed computing systems may use SOAP and HTTP to communicate with web services located at remote locations throughout a network, such as the Internet. For example, a user operating a client system at one location may use the Internet as a vehicle to execute remote function calls on a remote web server. A remote function call may invoke method executions on web service software components at the web server to produce output data, which is passed back to the client system. Different from standard remote function call systems, however, the .NET web service architecture uses proxy objects that are created at the client system to interface with web servers that host the web services. A proxy object is software that acts on behalf of a web service implemented by a remote web server. Accordingly, when the client system invokes the web service, the proxy object associates itself with the web server hosting the invoked web service to produce results to the user at the client system as if the remote service was hosted on the client system.

Although web service environments such as the .NET web service architecture enable distributed heterogeneous computing systems to share software components through the Internet, they require a software developer to create a proxy object for each web service consumed by a computing system. Thus, when a developer creates a web service client that consumes one or more web services, such as a web server that collects web services for a user system, the developer must program the web server with proxy objects that are associated with each of the one or more web services. Further, other consumers of the web service, such as other web service clients, must also be programmed with the corresponding proxy objects. Accordingly, when a developer modifies an existing (or-generates a new) web service, the developer must reprogram each consumer of the service to ensure the proxy object for the modified (or newly generated) service is updated at the corresponding web service consumer. When a web server invokes a web service, the server executes its proxy object code, created during development, that creates a proxy object that identifies the path to the corresponding web service using, for example, a Service Description Language (SDL) file. The proxy object works with the web service to generate results based on the invocation request from the client. Accordingly, proxy objects play a major role in retrieving results from remote web servers in conventional web service environments. Also, because proxy objects must pre-exist on a web server for every possible web service available, there exits the possibility that a web service may be invoked accidentally by a program bug, or illegally by an unauthorized user who gains access to the web server.

In addition to proxy objects, web service environments also rely on client-specific software for rendering content to a user. For instance, at design time, a developer may create customized content, such as a template with empty fields, for different functions performed by each web service that may be invoked by a web service consumer (e.g., web service client system). As one can imagine, changes to the template may require modifications to the content code for the template and, possibly, reprogramming of the client-specific software for rendering the changed template.

Further, web service environments require a consumer of a web service to know the types and numbers of data fields (e.g., parameters) a web service uses to produce its results. For example, in an environment where a server collects web service results for a remote user, the server must be configured to provide the proper types and numbers of data fields to a web service based on the user's request. Accordingly, a developer may, at design time, retrieve WSDL documents associated with a web service to collect information reflecting the types of methods performed, and the results generated, by that service. Based on this information, the developer programs the server's software (e.g., proxy objects, templates, etc.) such that the server provides the proper information (e.g., the correct number and types of data fields) to the web service based on the method executed by that service. Therefore, the server includes business logic that processes the information exchanged with a user and an invoked web service. The business logic also may handle configuring and rendering content for the user based on results received from any invoked web services. Thus, in such server configured web service environments, modifying a web service, or a template for the service, may require significant reprogramming of software to ensure the server provides the proper data field information to the proper invoked web service.

Although conventional web service environments enable users to access services distributed across a network, such as the Internet, their reliance on proxy objects and client-specific software restrict the efficiency of operating and modifying services in such distributed systems.

### SUMMARY OF THE INVENTION

Accordingly, there is a need for improved methods, systems, and articles of manufacture for automatically establishing a web service enterprise that overcomes the deficiencies of conventional web service architectures.

Among other things, methods, systems, and articles of manufacture consistent with embodiments of the present invention enable a distribution server to dynamically provide a web service enterprise to a user based on a user profile using a generic interface that is used to invoke any web service included in the enterprise.

In one embodiment consistent with the present invention, a method is provided for providing a web service to a user. The method may include determining a set of web services the user is authorized to access based on a user profile and receiving a request by the user to invoke a web service from the set of authorized web services. Also, the method may include locating the web service using a first data value included in a set of data values that are defined based on the user request and invoking the web service using a generic interface that is capable of invoking at least one other web service. Based on additional data included in the set of data values, result data may be generated by the web service. Moreover, the method may also include generating result content from the result data and displaying the result content to the user.

In another embodiment, a method is provided for distributing content to a user in a distributed web service environment including a directory server, a client system operated by a user, and web services including an authentication web service. The method may include receiving a request by the user to access the directory server, invoking the authentication web service using an identifier and location data corresponding to the authentication web service included in the directory service, and authenticating the user using user information included in the request. Further, the method in this embodiment may include retrieving session tags associated with the authenticated user from a directory service. The session tags may identify, for the user, a set of authorized web services and their corresponding location in the environment. Also, the method may further include generating, at the directory server, a session directory map using the session tags. The session directory map may be temporarily stored in memory on the directory server during a user session between the authenticated user and the directory server. Additionally, the method may include providing a web page to the client system including content corresponding to at least one of the authorized web services that, when selected by the user, initiates a request to invoke the at least one of the authorized web services.

In yet another embodiment of the present invention, a method is provided for saving current state information in an environment including a client system operated by a user and a directory server that manages access to web services including a host web service that has been invoked by the directory server and is executing a process for the user during a user session between the directory server and the client system. The client system may include a browser that displays a web page including a set of data fields corresponding to the host web service. The method may include receiving a request to save the current state of the user's browser during the user session, and setting as a function of the request a first hidden field to identify a storage web service, a second hidden field to identify a save function to be performed by the storage web service, and a third hidden field to identify the host web service. Further, the method may involve providing the first, second, and third hidden fields, and the set of data fields, from the client system to the directory server and invoking the storage web service using the first hidden field and a generic interface that is used by the directory server to invoke any of the web services. Additionally, the method may include storing, by the storage web service, the data fields and hidden fields in a database as a single stream of XML data, and generating result content indicating that the browser state information is successfully saved.

In another embodiment of the present invention, a method is provided for dynamically provisioning a web service enterprise that includes receiving a request to invoke a web service from an authorized user. Also, the method includes executing a generic interface to locate and invoke the web service to produce result data and providing the result data to the user. The generic interface is capable of invoking other web services included in the web service enterprise.

In another embodiment of the present invention, a method is provided for dynamically establishing a web service enterprise in a distributed system during a user session between a distribution server and a client system operated by the user. The method may include determining during the user session any web services that the user is authorized to access based on a user profile and creating a temporary session directory in memory that identifies the authorized web services and their location in the distributed system. Further, the method of this embodiment may include managing an exchange of data between the client system and the authorized web services during the user session such that web services are invoked using a common preprogrammed interface to produce result data that is displayed at the client system in customized content rendered based on the user profile. Additionally, the method includes removing the temporary session directory from memory when the user session ends.

Additional embodiments associated with systems and computer-readable medium corresponding to each of the above embodiments are also provided.

Further, in another embodiment of the present invention, a system is provided for dynamically providing a web service enterprise including web services the system may include a client system operated by an authorized user and a distribution server configured to provide content information used by the client system to generate a customized web page for the authorized user based on a user profile. In this embodiment of the invention, the system may be configured such that the customized custom web page includes web service content corresponding to a web service that the authorized user is allowed to access and one or more hidden fields that are set with data values in response to the user selecting the web service content in the customized web page. Further, the system may be configured such that the content information is based on web service information received from the web service that is invoked by the distribution server using a preprogrammed interface in response to the user selection, and the distribution server uses the preprogrammed interface to locate and invoke any other of the web services included in the enterprise.

In an additional embodiment of the invention, a system is provided for dynamically providing web services to a user including a plurality of servers each implementing one or more web services that perform one or more processes that produce corresponding result data. The system may also include a client system operated by a user including software that, when executed by a processor, sets data values to one or more hidden fields and a user data field associated with an authorized web service included in the one or more web services based on input received by the user. Further, the system may include a distribution server that is configured to receive the one or more hidden fields and a user defined data field from the client system. The distribution server may also generate a temporary directory map identifying the authorized web service and its location in the system based on a user profile during a user session between the client system and the distribution server. Additionally, the distribution server may remove the temporary directory map when the user session ends. Also, the distribution server may provide the hidden data fields and user data field to the authorized web service using a preprogrammed interface that is used to invoke any of the one or more web services. Also in this embodiment, the distribution server may receive result data generated by the authorized web service using the at least one of the hidden data fields and the user data field, and generate content information based on the result data that is used to by the client system to provide the client side content.

In still another embodiment of the invention, a system is provided for dynamically providing web services, including a client system and a computing system configured to dynamically configure a web service enterprise for,an authorized user including a set of the web services that the authorized user is allowed to access. In this embodiment, the computing system manages the exchange of data between the set of web services and the client system using a preprogrammed interface that establishes a communication session with any of the web services included in the set of web services. The data may include request data provided by the client system in response to an invocation request by the user and result data generated by a web service included in the set of web services in response to the invocation request provided by the user.

It is to be understood that both the foregoing general description and the following detailed description are exemplary and explanatory only and are not restrictive of the invention, as described. Further features and/or variations may be provided in addition to those set forth herein. For example, the present invention may be directed to various combinations and subcombinations of the disclosed features and/or combinations and subcombinations of several further features disclosed below in the detailed description.

### BRIEF DESCRIPTION OF THE DRAWINGS

The accompanying drawings, which are incorporated in and constitute a part of this specification, illustrate various embodiments and aspects of the present invention. In the drawings:

FIG. 1 illustrates an exemplary system environment for implementing certain embodiments of the present invention;

FIG. 2 illustrates a block diagram of a system model representing different component layers consistent with embodiments of the present invention;

FIG. 3 illustrates a block diagram of an exemplary harness consistent with embodiments of the present invention;

FIG. 4 illustrates a block diagram of an exemplary web page rendered to a user consistent with embodiments of the present invention;

FIG. 5 illustrates a block diagram showing a Flow flow for an exemplary authentication process consistent with embodiments of the present invention;

FIGS. 6 and 7 are flowcharts of the exemplary authentication process associated with FIG. 5 consistent with embodiments of the present invention;

FIG. 8 illustrates a block diagram showing a Flow flow for an exemplary web service invocation process consistent with embodiments of the present invention;

FIGS. 9 and 10 are flowcharts of the exemplary web service invocation process associated with FIG. 8 consistent with embodiments of the present invention;

FIG. 11 illustrates a block diagram showing a Flow flow for an exemplary save process consistent with embodiments of the present invention;

FIGS. 12 and 13 are flowcharts of the exemplary save process associated with FIG. 11 consistent with embodiments of the present invention; and

FIG. 14 is a flowchart of an exemplary web service modification process consistent with embodiments of the present invention.

### DETAILED DESCRIPTION

Methods, systems, and articles of manufacture consistent with the present invention automatically establish a web service enterprise for an authorized user of a distributed web service system. In one embodiment consistent with certain principles related to the invention, a Virtual Distribution Portal (VDP) server (i.e., the harness) is provided that automatically configures one or more web services for a user operating a client system based on user profile information. The client system displays content including web service content that invoke a web service authorized for use by the user. Thus, based on the user's profile, only authorized web services are presented to the user on the displayed content.

When the user selects a web service through the displayed content, the client system sets values for certain fields included in the content, including hidden fields, and passes the field information to the VDP server. Based on the field information, the VDP server locates the web service and creates data field arrays using the received field information. The VDP server then provides the data field arrays to the located web service, where an appropriate function is performed using the field information to produce result data. The web service provides the result data back to the VDP server where it may be converted into HTML content for display at the client system.

In this configuration, the VDP server uses a generic interface for communicating with selected web services dynamically as opposed to generating proxy objects to communicate with web services. Each web service may include the same generic interface, thus enabling the VDP server to establish communication sessions with the web servers without having to configure and program proxy objects. The above mentioned features allow some embodiments consistent with the present invention to configure and modify web services without having to reprogram the VDP server as a consumer of the modified web services. Instead, a developer need only modify the program code of the web services to update or deploy new services.

Accordingly, embodiments of the present invention enable the VDP server to dynamically create a web service enterprise for a user once the user is authenticated. The VDP server may establish an enterprise of one or more web services for the authorized user using a directory map that is temporarily stored within the server in memory during a user session between the VDP server and a client system operated by the user. When the user session ends, the VDP server removes the directory map thereby terminating the user's access to these services. Because the VDP server does not include any web service information until a user is authorized, an unauthorized user or program bug can not accidentally invoke a web service prior to user authorization through the VDP server.

Embodiments of the present invention may be implemented in various environments. Such environments and related applications may be specially constructed for performing the various processes and operations of embodiments of the invention or they may include a general purpose computer or computing platform selectively activated or reconfigured by program code to provide the necessary functionality. The exemplary methods disclosed herein are not inherently related to any particular computer or other apparatus, and aspects of these processes may be implemented by a suitable combination of hardware, software, and/or firmware. For example, various general purpose machines may be used with programs written in accordance with teachings of the invention, or it may be more convenient to construct a specialized apparatus or system to perform the required methods and techniques.

The present invention also relates to computer readable media that include program instruction or program code for performing various computer-implemented operations based on embodiments of the methods and processes of the invention. The program instructions may be those specially designed and constructed for the purposes of the invention, or they may be of the kind well-known and available to those having skill in the computer software arts. Examples of program instructions include for example machine code, such as produced by a compiler, and files containing a high level code that can be executed by the computer using an interpreter.

Reference will now be made in detail to exemplary embodiments of the invention, examples of which are illustrated in the accompanying drawings. Wherever possible, the same reference numbers will be used throughout the drawings to refer to the same or like parts.

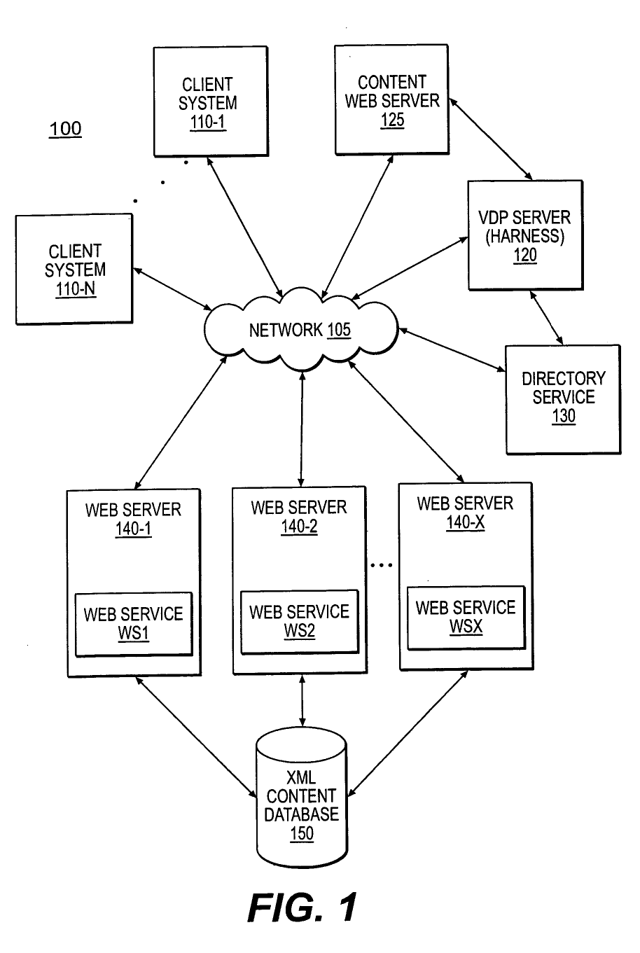

FIG. 1 illustrates an exemplary system environment 100, in which certain embodiments and features of the invention may be implemented. In one embodiment, environment 100 is configured using aspects of the .NET web service architecture. Other web service architectures, however, maybe implemented by embodiments of the present invention. For example, environment 100 may be configured using an architecture that allows a web service to invoke another web service using a common interface. Also, environment 100 may be configured using an architecture that allows a web service that communicates with a distribution server to invoke another web service used by remote systems that includes an interface different from the web service interface implemented within environment 100). As illustrated in FIG. 1, the system environment 100 includes a network 105, one or more client systems 110-1 to 110-N (N being an integer greater than 1), a VDP server (i.e., “harness”) 120, a content web server 125, a directory service 130, one or more web servers 140-1 to 140-X (X being an integer greater than 1), and an XML content database 150.

Network 105 may include one or more communication networks, including the Internet or any other similar network that supports web-based processing.

Client systems 110-1 to 110-N may each represent a computing system operated by a user, such as a desktop computer, workstation, laptop, personal digital assistant or any other similar client side system known in the art. Client systems 110-1 to 110-N may each include known computing components, such as a display device, input/output devices, processing devices, and memory including executable and non-executable data. For example, each of the client systems 110-1 to 110-N may be equipped with browser software such as Netscape Navigator, Microsoft Internet Explorer, or any other software that, when executed by a processor, allows the user to request and receive information (e.g., content) from one or more computing systems connected to network 105.

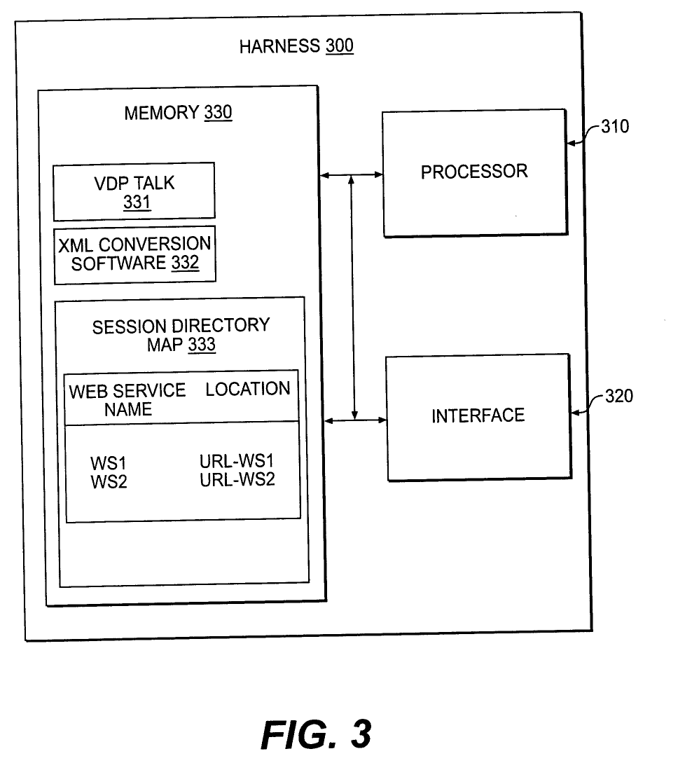

Harness 120 may be a server side computing system that may be configured as a web server or any other similar server-side system known in the art. Further, harness 120 may be associated with a business entity that provides business services to one or more authorized users, such as the users operating client systems 110-1 to 110-N. In one embodiment, harness 120 acts as a web service routing and control server that exchanges information between client systems 110-1 to 110-N, content server 125, directory service 130, and/or web servers 140-1 to 140-X. Harness 120 is configured to automatically form a web service enterprise for an authorized user operating a client system 110 (e.g., system 110-1) based on profile information corresponding to that user. Additional features associated with the operations of an exemplary harness consistent with the features of harness 120 are described below with respect to FIG. 3.

Content web server 125 may be a web server that is configured to generate and distribute content to a computing system connected to network 105, such as client systems 110-1 to 110-N. Further, content web server 125 may be associated with the same or different business entity than that associated with harness 300. In one embodiment of the invention, content web server 125 is configured under Microsoft's® Net framework and generates Hyper Text Markup Language (HTML) content based on information provided by harness 300. Content web server 125 may provide the generated HTML content to client systems 110-1 to 110-N for presentation through the client systems' browsers. Content web server 125 may be any type of web server that is capable of generating and distributing content, such as web servers provided by Websphere, iplanet, etc.

Directory service 130 is a computing system including a secured data store (e.g., SQL server, Oracle server, etc.) that contains location and description information of all web services available to one or more of the authorized users operating client systems 110-1 to 110-N. In one embodiment, directory service 130 includes a data structure (e.g., table, map, array, etc.) associating each user with one or more web services authorized for use by the user. Further, the data structure includes location information that identifies where in environment 100 each web service WS1 to WSX may be found, such as a URL of a web service provided by a web server 140-1 to 140-X. In one embodiment, directory service 130 may associate one or more web services WS1 to WSX to one or more users based on certain profiles determined by a harness administrator during runtime or development. For example, web services WS1 to WSX may be associated with an anonymous profile (reflecting no identified user), with a role profile (reflecting specific user types, such as administrator, technician, etc.), with a company profile (reflecting a specific look and format for each company), and a user profile (reflecting specific services offered to a specific user).

A developer may generate and/or update the data structure based on the various profiles. For example, the harness administrator may configure directory service 130 such that the configuration restricts access of a human resource specialist of a particular business entity to web services that strictly perform human resource functions, such as payroll updates, employee benefits updates, etc., while allowing a system administrator for the same business access to other types of web services.

Web servers 140-1 to 140-X may each be a computing system configured as a server to provide data to other computing systems, such as harness 300 and other web servers. Each web server 140-1 to 140-X may be associated with with the same business entity associated with harness 300. Alternatively, one or more of web servers 140-1 to 140-X may be associated with a business entity different from that of harness 300.

Web servers 140-1 to 140-X may receive, process, and/or provide results for, one or more requests for information, such as a request to perform a business function offered by the corresponding web server. In one embodiment of the invention, each web server 140-1 to 140-X may provide one or more web services (WS1 to WSX) that are accessible to authorized users through harness 300. Web services WS1 to WSX may each represent the software code and/or corresponding processing components (e.g., memory, processor devices, interfaces, etc.) that perform one or more web services provided by the-web server that hosts the service. A web service corresponds to processes implemented in hardware, software, or a combination of both, and executed by a data processing system operating with these web servers and/or other computing entities within environment 100 Each web service WS1 to WSX may perform similar or different types of services offered by the host web server (e.g., web server 140-1). For example, WS1 may represent a business process that determines and provides an insurance quote for a user, while WS2 may represent a business process that performs generic functions, such as saving content, authentication services, etc.

XML content database 150 includes XML format data, such as templates, menus, forms, color, graphics, fonts, etc. that may be applied to content (e.g., data, input values, business validation rules, etc.) produced by a web service (e.g., WS1). The XML format data may be used by harness 300 and/or content web server 125 to generate HTML for a web page that includes a web service's results. In one embodiment, XML content database 150 may include XML format data for each type of result produced by each web service (e.g., WS1 to WSX) implemented in environment 100. Accordingly, a web service (e.g., WS1) uses XML content database 150 to collect the appropriate XML format information needed to generate HTML content including the web service's results that is displayed by a client system's (e.g., system 110-1) browser.

As previously mentioned, various components of system environment 100 may be associated with a common business entity. In such an arrangement, the business entity may be configured to provide the same web services to users working in different business departments that are geographically distributed. Further, the business entity may provide the same web services to users who are not employees of the business entity, such as a customer or a separate company in partnership with the business entity.

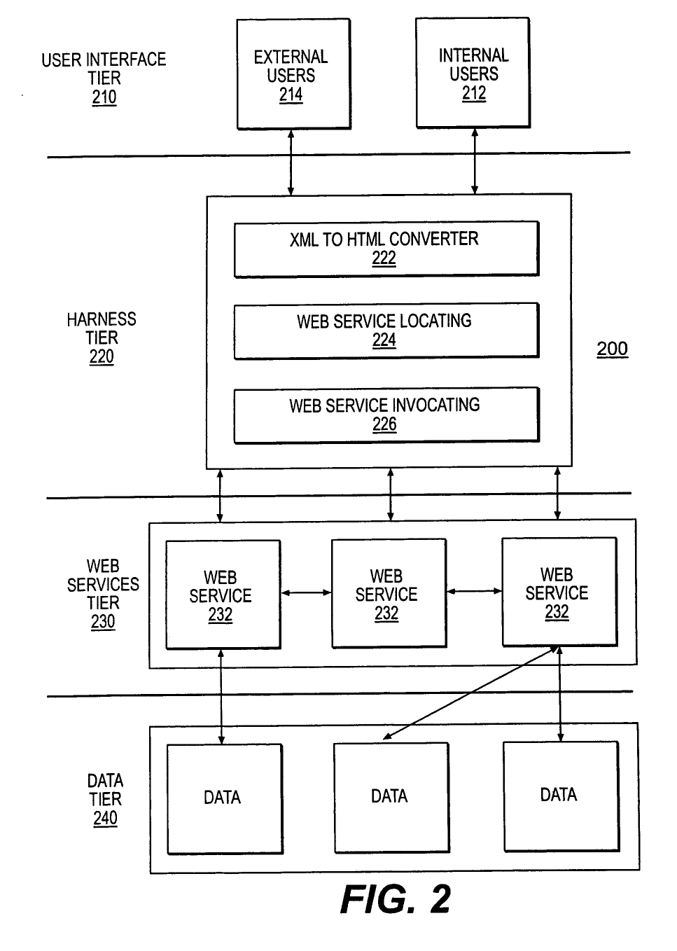

FIG. 2 shows a block diagram of an exemplary architecture model 200 associated with these embodiments. As shown, the architecture model 200 includes four tiers, a user interface tier 210, a harness tier 220, a web services tier 230, and a data layer tier 240. User interface tier 210 may represent a level associated with communication and interaction functions with internal users 212 and external users 214. Internal users 212 may represent one or more users that are associated with the business entity that leverages harness 300 and any associated web services WS1 to WSX to provide business processes. For example, an internal user 212 may be an employee of the business entity that has access to an Intranet hosted by the business entity. Through the Intranet, the user 212 may gain access to harness 300 and one or more web services 140-1 to 140-X managed by harness 300. External users 214 may represent one or more users that may not be associated with the business entity that leverages harness 300. For example, an external user 214 may be a user that accesses harness 300 through the Internet and a firewall maintained by the business entity to invoke a web service within environment 100.

Harness tier 220 represents a layer including components associated with functions provided by harness 300. For example, harness tier 220 may include a XML to HTML converter sub-layer 222 that allows XML data received from a web service to be converted to HTML for presentation at the user interface tier 210. Harness tier 220 may also include a web service locating sub-layer 224 that performs web service locating functions, such as determining the URL for a web service. Also, harness tier 220 may include a web service invocation sub-layer 226 that invokes the web services located by the web service locating sub-layer 224. Other sub-layers may be incorporated in harness tier 220 without departing from the scope of the present invention.

Web services tier 230 represents the functions and logic associated with the web services provided by web servers 140-1 to 140-X. Each service 232 included in web service tier 230 may exchange information with the harness tier 220 and other web services 232 in web service tier 230. Further, one or more web services 232 in tier 230 may be internal or external web services. An internal web service may be service provided by a web server that is associated with the business entity leveraging harness 300. An external web service may be a service provided by a web server associated with a business entity that cannot directly access harness 300. That is, the external web service may have to access harness 300 through an internal web service.

Data tier 240 represents a storage layer where all of the information used by the web services 232 in tier 230 use to perform their respective business functions. Data tier 240 may include data stores that maintain information used by web services 232 to perform certain services, such as authorization functions, insurance rate determinations, etc. Any web service 232 in web service tier 230 may access any data included in data tier 240, either directly or through another web service 232.

As indicated above, harness 300 is configured to perform routing and control functions that enable system environment 100 to dynamically generate and modify web service enterprises for individual authorized users. FIG. 3 shows a block diagram of an exemplary harness 300 consistent with certain embodiments of the present invention. As shown, harness 300 may include known computing system components, such as a processor 310, an interface device 320 for facilitating communications between other computing systems or a user, and one or more memory devices 330 that store data and program code used and/or executed by processor 310 to perform virtual distribution functions consistent with embodiments of the invention. For example, memory 330 may include a generic interface (VDP Talk 331) that harness 300 uses to communicate with web services WS1 to WSX. VDP Talk 331 may be a method that includes parameters and functions that invoke a selected web service identified by harness 300. In one embodiment of the invention, each web service WS1-WSX may also include a copy of a similar generic interface VDP Talk that interacts with VDP Talk 331 to invoke its corresponding web service. VDP Talk 331 may be preprogrammed by a developer when harness 300 is deployed in environment 100. Once programmed, embodiments of the present invention allow harness 300 to use VDP Talk 331 to access any existing, modified, and/or new web services in environment 100.

Memory 320 may also include XML conversion software 332 that creates software-based components (e.g., Microsoft® .Net web components) or transformed XML from XML data received from a web service (e.g., WS1) that are used by content web server 125 to generate HTML content for rendering by a client system's 110-1 to 110-N browser. Also, memory 330 may store a session directory map 333 that includes an array of web service information for an authorized user during that user's session with harness 300. Session directory map 333 may include web service identifier information (e.g., WS1, WS2) and corresponding web service locator information for the identified web services (e.g., URLs for web services WS1 and WS2). Additional features associated with VDP Talk 331, XML Conversion software 332, and session directory map 333 are described below.

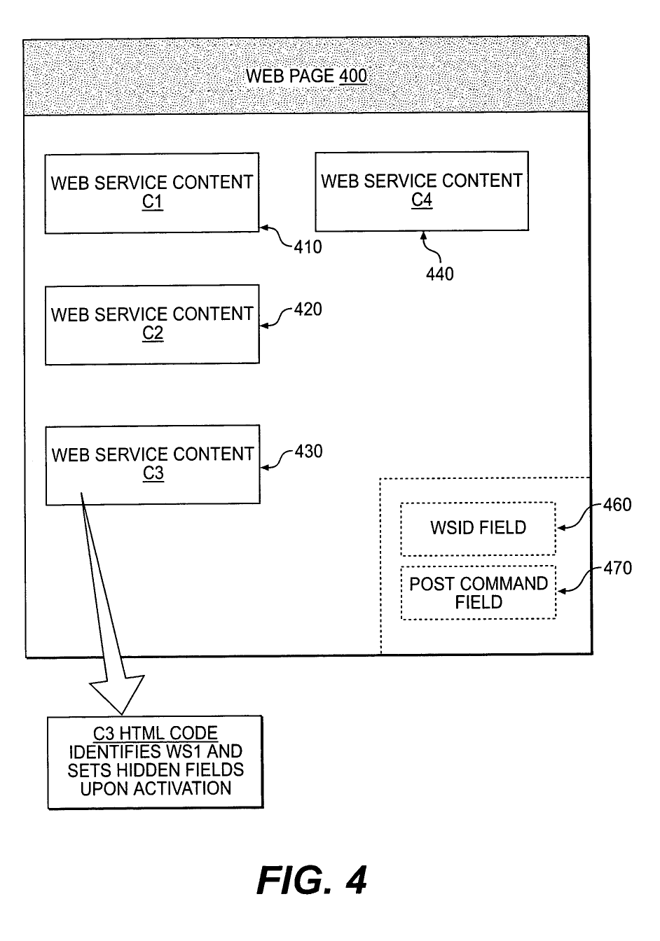

Harness 300 may operate as a routing mechanism for web services WS1 to WSX by transferring user web service invocation requests to web servers 140-1 to 140-X. A web service invocation request may be associated with a user selection on a customized web page rendered by content web server 125 through information provided by harness 300. To better illustrate the features of a web service invocation request, FIG. 4 shows an exemplary web page 400 that may be rendered by a client system (e.g., 110-1) using the HTML content provided by content web server 125.

As shown, web page 400 may include various content, such as text, graphics, hyperlinks, etc. In one embodiment, web page 400 may include web service content c1-c4, 410-440. respectively, that are associated with various business processes that may be performed by one or more web services WS1 to WSX. For example, web service content C1 410 may be associated with a business process that is performed by web service WS2, while web service content C3 430 is associated with a different business process performed by web service WS1. Each web service content 410-440 may be associated with HTML content that allows a user to provide one or more parameters included as data values for a respective web service content. For example, web service content C3 430 may be associated with a web service that provides an insurance rate quote for a particular type of asset. Accordingly, web service content C3 430 may include HTML content that allows the user to provide parameters associated with the asset, such as value, age, condition, etc. The parameters provided by the user are associated with corresponding user data fields that are used by the web service that generates the insurance rate quote.

Additionally, each web service content 410-440 includes client side HTML code that identifies the corresponding web service that performs the business process associated with the respective web service content. Also, each web service content 410-440 is associated with HTML code that sets values to one or more fields included in web page 400 based on the web service corresponding to the respective content. These fields may be “hidden” in that they are not displayed with content presented to a user, such as web service content 410-440. In one embodiment, each web page generated by the HTML content provided by content web server 125 includes a Web Service Identification (WSID) hidden field 460 and a post command field 470. WSID 460 is a field that identifies a web service (e.g., WS1 to WSX) and post command field 470 identifies a type of function or functions that the identified web service is to perform when invoked by harness 300. Initially, when web page 400 is rendered by client system 110-1, hidden fields 460 and 470 are empty (i.e., they contain no data values). When a user requests to invoke a web service by selecting (e.g. clicking via an input device, such as a mouse) a particular web service content (e.g., 430), the HTML code associated with the activated web service content sets values to fields 460 and 470. For example, FIG. 3 shows that web service content C3 430 is associated with web service WS1. Accordingly, when a user activates web service content 430, its HTML code sets a data value identifying web service WS1 in WSID field 460 and a data value in post command field 470 reflecting the type of business function WS1 is to perform when invoked by harness 300.

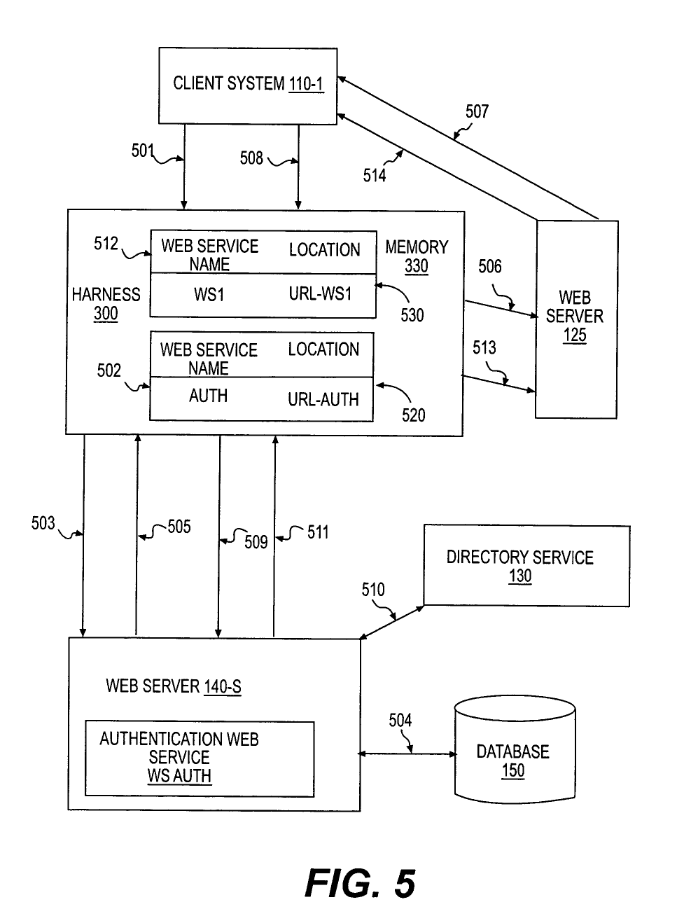

Web page 400 may be formatted based on a profile associated with the user that requests the page. Thus, the type of data and how it is presented is based on the user's profile. Further, the types of web service content 410-440 included in web page 400 is also dependent on the user's profile. FIGS. 5-13 illustrate how environment 100 uses user profile information to dynamically configure a web service enterprise for a user.

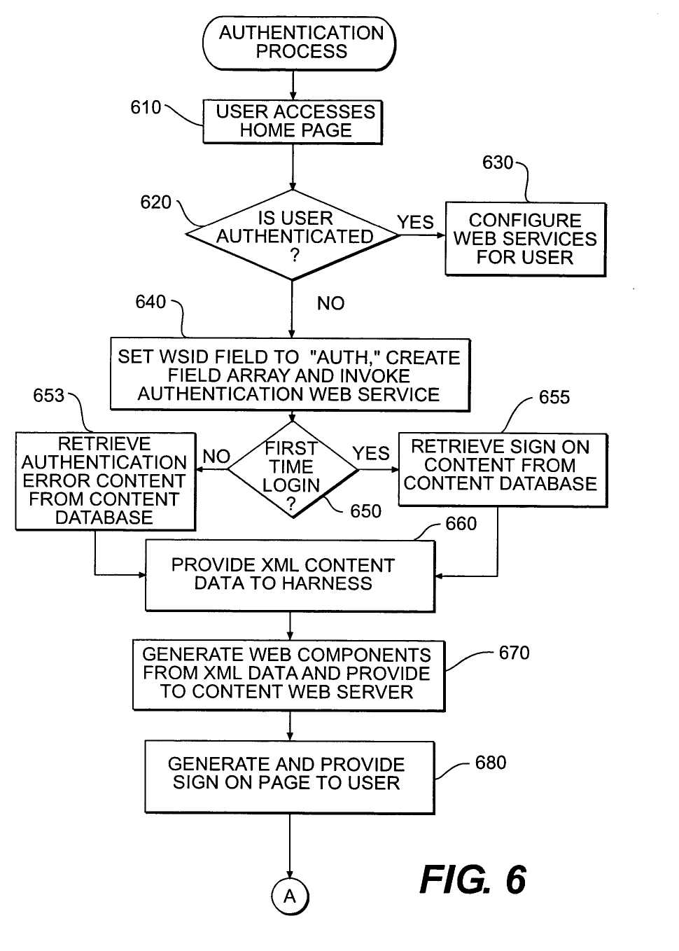

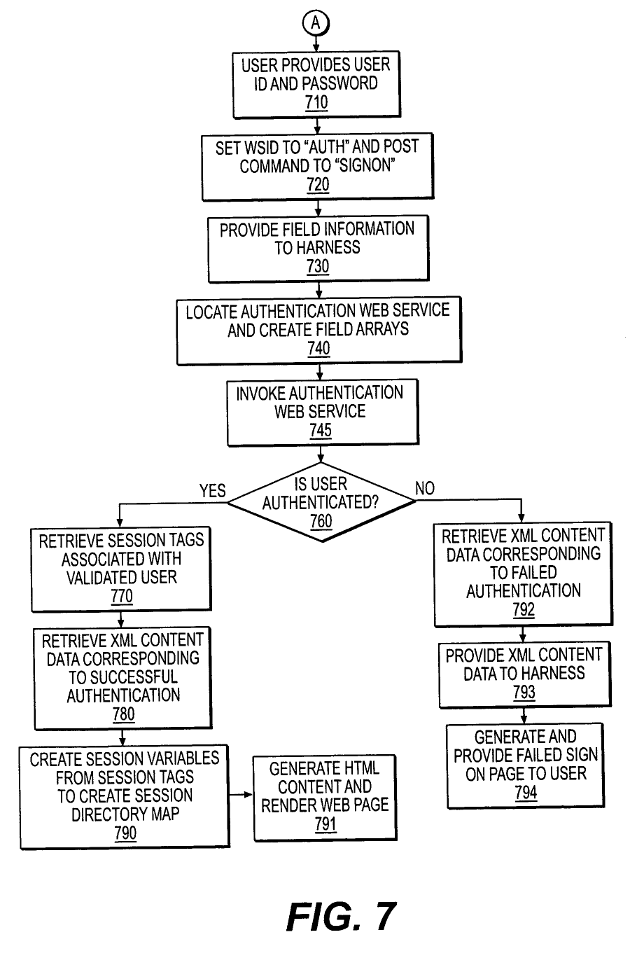

Initially, to gain access to one or more authorized web services, a user must be authenticated. FIGS. 5-7 show a block diagram and corresponding flowcharts reflecting an authentication process performed by environment 100 consistent with embodiments of the invention. FIG. 5 includes exemplary process flow arrows (labeled arrows 501 through 514) that correspond to various steps included in FIGS. 6 and 7.

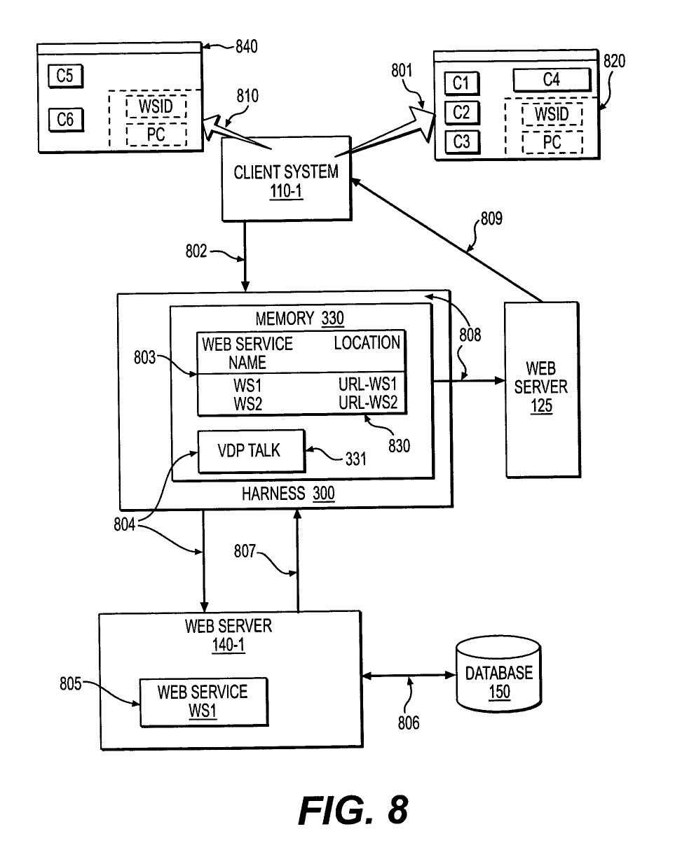

Referring to FIGS. 5 and 6, the authentication process may begin when a user operating a client system (e.g., client system 110-1) accesses a web site providing a web page (e.g., a home web page) (Flow 501 and Step 610 of FIG. 6). For example, the user may submit a URL through a browser that accesses a web site provided by harness 300. When harness 300 receives the user request, it determines whether the user is authenticated (Step 620). To determine whether the user is authenticated, harness 300 checks whether a current user session is established. In one embodiment of the invention, a user session is established when a user is properly authenticated and a user session variable is generated. Accordingly, if harness 300 detects a current user session variable, the user is considered authenticated (Step 620; YES) and harness 300 dynamically configures a customized web service enterprise for the authenticated user using a session directory map that is established from previous authentication and user sessions (Step 630). Features associated with the customized web service enterprise is described below with respect to FIGS. 8-10.

Referring back to Step 620, if the user is not authenticated (Step 620; NO) (i.e., harness 300 does not detect a user session variable), harness 300 sets a WSID field (similar to the WSID hidden field 460 in web page 400) to identify an authentication web service that performs authentication services for harness 300 (Flow 502 and Step 640). In this example, the authentication web service is identified as WS AUTH provided by web server 140-S, as depicted in FIG. 5. In one embodiment, harness 300 may be hard coded with a permanent session directory map 520 that includes an identifier for the authentication web service WS AUTH and its corresponding URL (e.g., http://www.harness.com/URL-AUTH.asmx). Accordingly, with the WSID field set at WS AUTH, harness 300 invokes WS AUTH by executing VDP Talk 331 to locate http://www.harness.com/URL-AUTH.asmx corresponding to the location of web service 140-S. Also, harness 300 may create field arrays that include data field identifiers and corresponding data field values. Harness 300 fills these arrays with any field information that corresponds to a web service that is being invoked. Accordingly, because harness 300 is invoking authentication web service WS AUTH, the only field information is WSID field and its corresponding value set at AUTH.

Once, VDP Talk 331 locates WS AUTH at web server 140-S using the URL information in permanent session directory map 520, a copy of the VDP Talk interface included in WS AUTH and VDP Talk 331 in harness 300 collectively establish a communication session between harness 300 and web server 140-S. Harness 300 then provides the two field arrays to WS AUTH (Flow 503) using, for example, SOAP function calls.

Authentication web service WS AUTH analyzes the received field arrays to determine whether the user request is a first time login session (Step 650). To determine this, in one embodiment, WS AUTH analyzes the received field arrays to determine whether they include a post command field and/or a corresponding data value. If WS AUTH detects a post command field (Step 650; NO), the user session is not associated with a first time login because post command field data values are provided by the client side HTML code for authenticated user web pages rendered by the client system's 110-1 browser. Accordingly, WS AUTH ends authentication services and retrieves XML content data from XML content database 150 for rendering an authentication error web page to the user (Flow 504 and Step 653).

On the other hand, if WS AUTH determines that the user request is a first time login session (Step 650; YES), retrieves XML content data from XML content database 150 for rendering a sign on web page to the user (Flow 504 and Step 655). The XML content data retrieved by WS AUTH may include format data, such as data styles (e.g., font, colors, etc.) that are used by harness 300 and content web server 125 to generate a customized web page to the user. In one embodiment of the invention, the XML content data may also include extensible Stylesheet Language Transformation (XSLT) information that provides content rendering rules for XML data based on the user's profile. In another embodiment, a branding identifier may be passed to harness 300 that associates XSLT rendering rules that harness 300 uses to determine the type of content that should be rendered in a customized web page. For example, for a user associated with a company profile, an XSLT rendering rule may require that any web page content generated for that user includes data for specific company logos and graphics. Once retrieved, WS AUTH provides the XML content data and any data fields previously provided in the data arrays provided in Step 640 to harness 300 (Flow 505 and Step 660).

Harness 300 may then transform the XML content data using the one or more XSLT information included in the XML content data provided by WS AUTH and database 150. The XSLT information identifies the “look and feel” styles that the XML content should be rendered when transformed into HTML content. Harness 300 converts the transformed XML content data into web components and sends the components to content web server 125 (Flow 506 and Step 670). Once received, content web server 125 may use the XML content data to organize a template that is used to render content to the user. The template may contain one or more panels, such as a banner panel, a footer panel, side panels, and one or more center content panels. Further, content web server 125 converts the web components into HTML content data reflecting the styles identified by the XSLT information, and provides the HTML content data to client system 110-1 for rendering as either an authentication error web page (in the event WS AUTH determines that the user session was not a first time login session) or a sign on web page (Flow 507 and Step 680). Following the presentation of the authentication error web page, the authentication process ends.

Referring now to FIGS. 5 and 7, the sign on web page may include content reflecting one or more fields from which the user may enter authentication information. For example, the sign on web page may include two fields that allow the user to provide user ID and password data values and a web service content button associated with the authentication web service WS AUTH. Furthermore, the sign on web page includes empty WSID and post command hidden fields. Accordingly, the user provides the user ID and password data and activates the authenticate web service content by selecting (e.g., clicking with a mouse) the content button (Step 710). Upon activation, client side HTML code associated with the authentication web service content button sets the WSID hidden field to AUTH (identifying the authentication web service WS AUTH) and the post command to “Signon” (reflecting a sign on process that is to be performed by WS AUTH) (Step 720). Client system 110-1 then sends the filled in field information (e.g., WSID field, post command field, user ID field, and password field) to harness 300 (Flow 508 and Step 730).

Harness 300 analyzes the WSID field to identify the web service that is to be invoked. In this case, harness 300 determines that WS AUTH is identified in the WSID hidden field, and therefore accesses the permanent session directory map 520 to determine its location using the URL information stored therein (e.g., http://www.harness.com/URL-AUTH.asmx) (Step 740). Also, at Step 740, harness 300 creates the two field arrays with the received field information. In this example, the two field arrays include a field array containing the field names identifying the WSID, post command, user ID, and password fields, and a field array including the corresponding values for the identified fields in the first array. Harness 300 may then execute VDP Talk 331 to establish a communication session with the VDP Talk interface included in WS AUTH using the URL information stored in the permanent session directory map 520. Once the session is established, harness 300 invokes WS AUTH and sends the two field arrays to web server 140-S for use by WS AUTH (Flow 509).

WS AUTH then determines whether the user is valid by checking the password and user ID field data values against a data structure including user IDs and corresponding passwords for all authorized users of harness 300 (Step 760). The data structure may be stored in database located in web server 140-S or in a remote database. If the user is valid (Step 760; YES), WS AUTH may access directory service 130 to retrieve session tags associated with the user (Flow 510 and Step 770). The session tags correspond to the information stored in the data structure associating the authorized user with one or more web services. In this example, the user is authorized to access web service WS1 to perform any business functions associated with that service. Accordingly, the session tags may include an identifier for WS1 and its corresponding URL information. WS AUTH also retrieves XML content data from XML content database 150 corresponding to the format data used to render a customized web page for the user (Flow 504 and Step 780). WS AUTH combines the session tags and XML content data into an XML data stream and sends the stream to harness 300 (Flow 511). Harness 300 creates session variables (e.g., web service identifier WS1 and its URL-WS1) from the session tags and creates a temporary session directory map 530 including these session variables (Flow 512 and Step 790). Harness 300 also converts the received XML content data into web components and provides the components to content web server 125 (Flow 513). Content web server 125 converts the web components into HTML content and provides the HTML content to client system 110-1 for rendering a customized web page that includes a web service content button associated with WS1 (Flow 514 and Step 791). Harness 300 is now ready to invoke any authorized web services requested by the user (e.g., WS1). This process is described in greater detail below with respect to FIGS. 8-10.

Returning to Step 760 of FIG. 7, in the event WS AUTH fails to validate the user (Step 760; NO), WS AUTH retrieves XML content data from XML content database 150 corresponding to a failed authentication by the authentication web service (Step 792). WS AUTH sends the XML content data to harness 300 as an XML data stream (Step 793). Harness 300 converts the XML content data into web components and sends the components to content web server 125, which generates and provides HTML content to client system 110-1 corresponding to a failed sign on web page (Step 794).

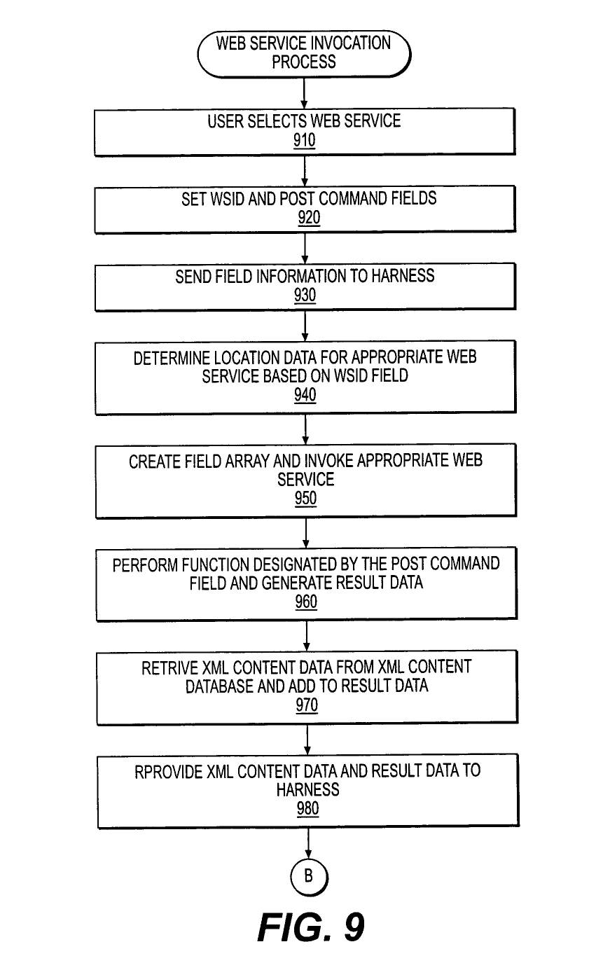

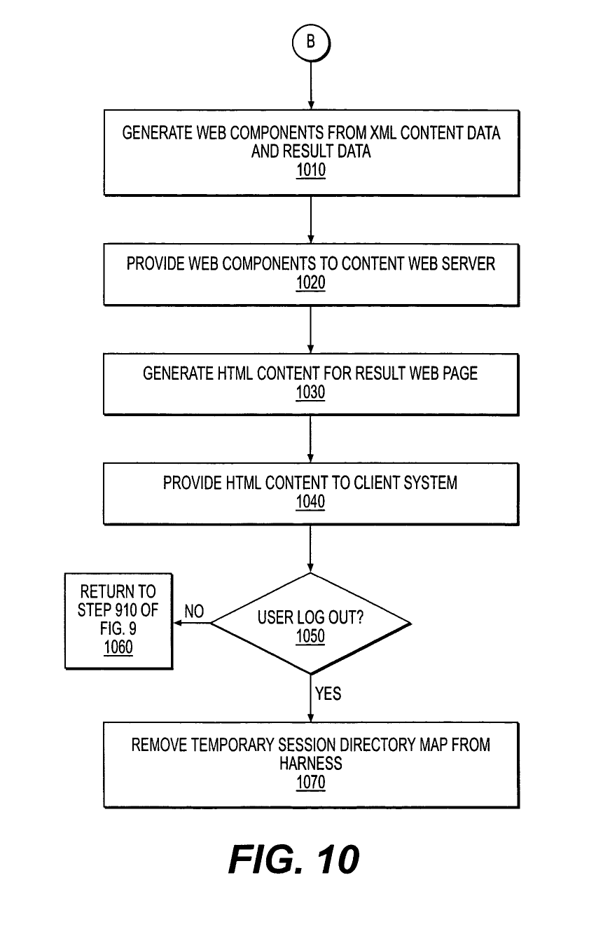

FIGS. 8-10 show a block diagram and corresponding flowcharts reflecting a web service invocation process performed by environment 100 consistent with embodiments of the invention. FIG. 8 includes exemplary process flow arrows (labeled arrows 801 through 810) that correspond to various steps included in FIGS. 9 and 10.

Referring to FIG. 8, a user is initially presented with a web page including customized content based on the user's profile (Flow 801). FIG. 8 shows an exemplary web page 820 that includes content including web service content buttons C1-C4. In this example, buttons C1 and C2 correspond to web service WS2 and buttons C3 and C4 correspond to web service WS1. Further, web service content button C3 is associated with a data field (not shown) that allows a user to provide a parameter to be used by WS1 when performing the function corresponding to the business function of button C3. Also, web page 820 includes WSID and post command (PC) hidden fields, which are initially empty.

To invoke a web service, the user operating client system 110-1 selects a corresponding web service content button after filling out any associated data fields (if necessary) (Step 910). In this example, the user selects web service content button C3 after providing a parameter for button C3's associated data field. Based on the user selection, client side HTML code associated with button C3 sets the WSID hidden field to WS1 and the PC hidden field to the appropriate function to be performed by WS1 (e.g., “getquote” corresponding to an insurance rate calculation function performed by WS1) (Step 920).

Client system 110-1 may then provide the field information to harness 300 (Flow 802 and Step 930). In this example, the field information includes the field data associated with button C3, WSID equal to WS1, and PC equal to “getquote.” Additionally, client system 110-1 may provide all the remaining field information included in web page 820 whether or not they include corresponding data values. Thus, harness 300 may receive empty field information and field information with data values from client system 110-1. Harness 300 uses the WSID hidden field data to determine the web service being invoked by the user and the web service's location (Step 940). In this step, harness 300 accesses the temporary session directory map 830 that was previously established by harness 300 during the authentication process (Flow 803). In this example, because the user is authorized to access web services WS1 and WS2, directory map 830 includes web service identifiers for these web services and their corresponding URLs. Accordingly, harness 300 matches the WSID field of WS1 with the WS1 identifier in the temporary session directory map 830 and collects the URL for WS1.

Harness 300 may then create the two field arrays using the field information provided by client system 110-1 and executes VDP Talk 331 to establish a communication session with the VDP Talk interface included in WS1 to invoke WS1 (Flow 804 and Step 950). In this example, the field arrays may include the field identifiers for every field included in web page 820 and their corresponding field data values (whether or not they are empty and/or include a data value). Harness 300 then sends the two field arrays to WS1 using the communication session established between the two VDP Talk interfaces.

WS1 analyzes the received data arrays to check the PC hidden field data value. Based on the PC field value, which in this example is set as “getquote,” WS1 performs the appropriate business function to generate result data (e.g., calculates an insurance rate quote using the data field provided by the user through web service content button C3) (Flow 805 and Step 960). Once the result data is generated, WS1 retrieves XML content data from XML content database 150 corresponding to the format for a result web page generated by content web server 125 (Flow 806 and Step 970). WS1 places the XML content data and result data in an XML data stream and sends the stream to harness 300 (Flow 807 and Step 980).

Referring to FIGS. 8 and 10, harness 300 generates web components from the XML content data, result data, and any XSLT rules previously collected by the authentication process (Step 1010) and provides the web components to content web server 125 (Flow 808 and Step 1020). Content web server 125 uses the web components to generate HTML content for a result web page (Step 1030) and provides the HTML content to client system 110-1 (Flow 809 and Step 1040). The browser executing in client system 110-1 may use the received HTML content to generate a result web page 840 and displays the page to the user (Flow 810). The result web page 840 may include various information, including non-active text, graphics, banners, etc. based on the HTML provided by content web server 125. Further, the result web page 840 may include newly generated web service content buttons corresponding to web service WS1 or other web services (e.g., content buttons C5 and C6). Also, result page 840 includes empty WSID and PC hidden fields.

The user may decide to either end the current user session (e.g., log out) or continue with the user session by selecting the web service content buttons C5 or C6 (Step 1050). Accordingly, if the user does not end the current user session (step 1050; NO), the web service invocation process continues at Step 910 of FIG. 9 (Step 1060). On the other hand, if the user ends the user session by logging out (Step 1050; YES), harness 300 removes the temporary session directory map 830 corresponding to the user from memory 330 (Step 1070).

As described, embodiments of the present invention enable environment 100 to dynamically configure web service enterprises for authorized users using a generic interface present in the harness 300 and any web services managed by harness 300. Accordingly, harness 300 does not rely on individually generated proxy objects as does conventional web service architectures. Further, because harness 300 controls access to the web services in environment 100 and does not include any web service information until a user is authorized, a web service may not be invoked by an unauthorized user through harness 300.

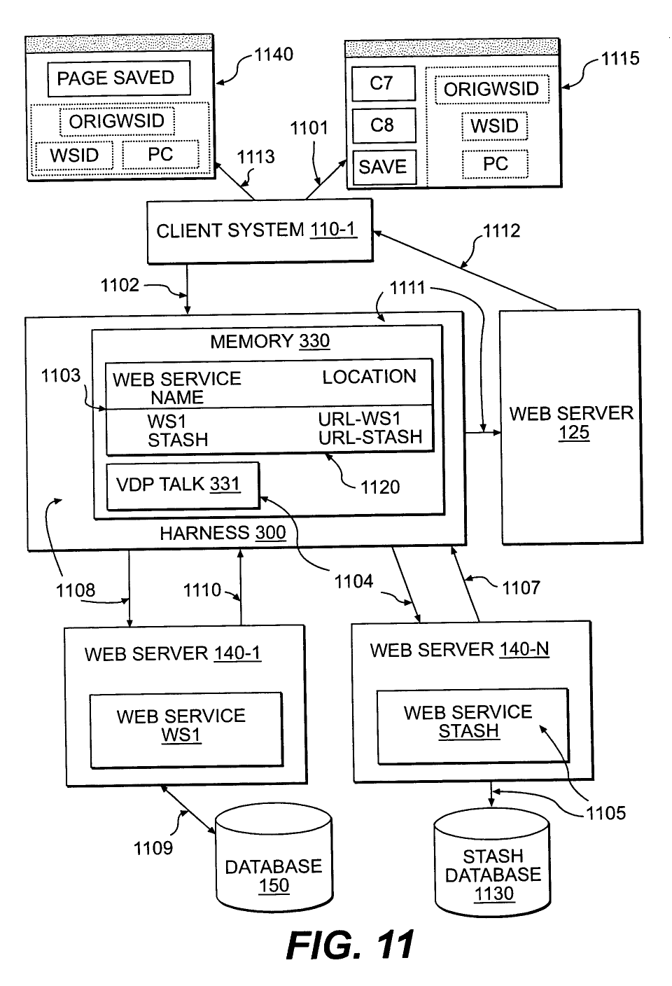

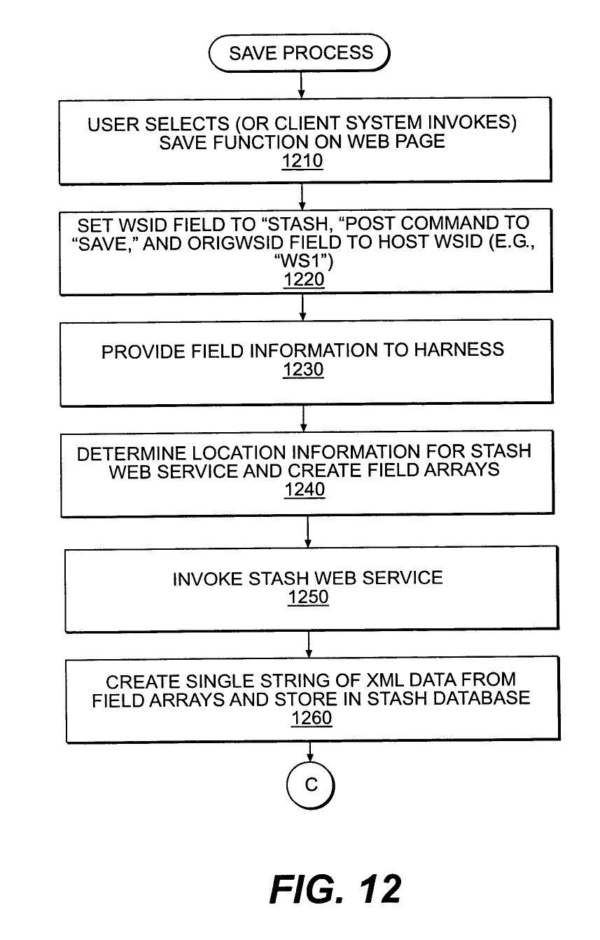

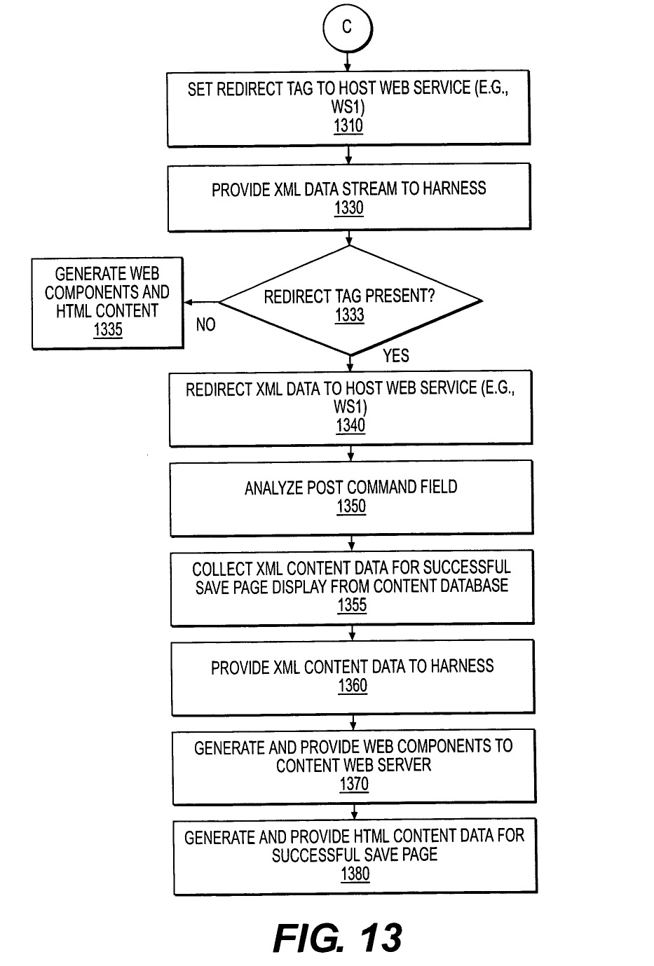

Additionally, the present invention includes additional embodiments that enhance and protect a user's session with harness 300. For example, in one embodiment, environment 100 allows user field information to be manually or automatically saved at any time during a user session. This allows a user to retain all field information provided by the user during the session, which is beneficial in sessions that involve the user filling out lengthy forms, such as credit applications, insurance applications, etc. FIGS. 11-13 show a block diagram and corresponding flowcharts reflecting a web service save process performed by environment 100 consistent with embodiments of the invention. FIG. 11 includes process flow arrows (labeled arrows 1101 through 1113) that correspond to various steps included in FIGS. 12 and 13.

Referring to FIGS. 11 and 12, a user is initially presented with a web page including customized content based on the user's profile (Flow 1101). FIG. 11 shows an exemplary web page 1115 that includes content including web service content buttons C7 and C8. In this example, button C7 corresponds to web service WS2 and button C8 corresponds to web service WS1. Further, web page 1115 includes another web service content button “save” that corresponds to a web service for saving field information during a current user session. In this example, the saving web service is a “STASH” web service provided by web server 140-N. In addition to the WSID and PC hidden fields, web page 1115 may include another hidden field “ORIGWSID” that identifies a web service that is performing a function that generated the web page 1110 used by the user during the current user session. In this example, WS1 is the web service that is currently invoked to produce web page 1115.

At some point during the user session, the user may select the save web service content button to save current browser state information (e.g., field information included in web page 1115) (Step 1210). Alternatively, client system 110-1 may include client side program code that automatically and periodically activates the save web service content button. Also, client system 110-1 may include client side program code that determines whether the user is attempting to end a current user session without saving any current browser state information. Based on this determination, the client side program code may query the user to determine whether the user wishes to save the current state information. Alternatively, the client side program code may automatically save the current state information when the user ends the current user session without submitting any field information to harness 300.

Based on the user selecting the save web service content button, client side HTML code sets the WSID field to STASH, the PC field to “SAVE” (reflecting a save function to be performed by WS STASH), and the ORIGWSID field to WS1 (reflecting the web service currently invoked) (Step 1220). Client system 110-1 collects all of the current browser state information that is present in web page 1115, including all hidden and displayed fields, their corresponding data values (if any), any format data associated with the content displayed in page 1115, etc., and provides the collected information to harness 300 (Flow 1102 and Step 1230).

Harness 300 uses the WSID field to determine the web service that is to be invoked and its location. In one embodiment of the invention, harness 300 access the temporary session directory map 1120 that was generated when the user was authenticated by the authentication process (e.g., FIGS. 5-7). In this example, the user is authorized to access web services WS1 and STASH. Accordingly, based on the WSID field being set to STASH, harness 300 determines the URL for the STASH web service from the session directory map 1120 (Step 1240).

It should be noted at this point that embodiments of the present invention may allow a developer or administrator to associate every authorized user listed in the directory service 130 data structure with the STASH web service to enable the service to be offered in every web page presented to a user during a user session. Accordingly, the session tags provided by the authentication web service WS AUTH to harness 300 during the authentication process for an authorized user include tags reflecting the STASH web service and its corresponding URL information. Alternatively, the STASH web service may be associated with a user during a user session with a web service. For example, an invoked web service, such as WS1, may collect and add session tags associated with the STASH web service to the XML data stream its provides when returning result data to harness 300. Accordingly, harness 300 may extract the session tags when analyzing the XML data stream and use them to generate session variables for updating temporary session directory map with the identifier and URL for the STASH web service.

Returning back to FIG. 12, at Step 1240, harness 300 may also create the two field arrays using the field information received from client system 110-1. In this example, the field arrays will include a first field array identifying all of the hidden and displayed fields present in web page 1110 when the save content button was activated and a second array including all of the corresponding data values (if any) for the fields identified in the first array.

Harness 300 may then execute VDP Talk 331 to establish a communication session with the VDP Talk interface present in the STASH web service provided by web server 140-N using the URL information retrieved from the directory map 1120. Harness 300 then invokes the STASH web service and sends the two field arrays to STASH using the established communication path (Flow 1104 and Step 1250).

The STASH web service analyzes the PC hidden field data included in the data arrays, to determine the type of function to perform, which in this example is a save function corresponding to the PC field being set to “SAVE.” In one embodiment of the invention, the STASH web service may create a single string of XML data from the two field arrays and stores the string of XML data in a database or similar storage device, such as database 1130 (Flow 1105 and Step 1260).

Referring to FIGS. 11 and 13, the STASH web service uses the ORIGWSID field included in the received data arrays to create and set an XML redirect tag to identify the host web service that is invoked and running when the “save” content button was activated in Step 1210, (e.g., WS1) (Step 1320). The STASH web service adds the redirect tag with the field information saved in stash database 1130, forms this information into an XML data stream, and sends the stream to harness 300 (Flow 1107 and Step 1330).

Harness 300 analyzes the received XML data stream to determine whether any redirect tags are present (Step 1333). If no redirect tags exists in the XML data (Step 1333; NO), harness 300 generates web components from the XML content data for use by content web server 125 to provide HTML content to client system 110-1 (Step 1335). In one embodiment, harness 300 may be configured to always check for redirect tags whenever it receives an XML data stream from a web service. Accordingly, during the authentication process or web service invocation process, harness 300 checks for a redirect tag in received XML content data before generating any web components. In this example, the STASH web service set a redirect flag in the XML content data (Step 1333; YES). Accordingly, harness 300 redirects the received XML data to the web service identified by the redirect tag (e.g., web service WS1) (Flow 1108 and Step 1340). In one embodiment of the invention, harness 300 redirects the XML content data to the identified web service in the redirect tag by creating the two field arrays using the received XML data and providing the arrays to the identified web service using the VDP Talk interfaces associated with harness 300 and the web service (e.g., WS1).

WS1 analyzes the post command field included in the field arrays to determine the type of function to perform (Step 1350). In this example, the post command field has been set to “SAVE,” by the client side HTML code when the user activated the save web service content button in Step 1220 of FIG. 12. Accordingly, WS1 collects appropriate XML content data from XML content database 150 corresponding to format data for a “page saved” result web page that will be rendered to the user (Flow 1109 and Step 1355). WS1 forms an XML data stream from the collected XML content data and provides the stream to harness 300 (Flow 1110 and Step 1360).

After receiving the XML data stream, harness 300 checks for redirect tags, and if none are present, transforms the XML content data to web components using the format data and possibly any XSLT information retrieved by harness 300 during the authentication process, and sends the components to content web server 125 (Step 1370). Content web server 125 converts the web components to HTML content and provides the HTML content to client system 110-1 for rendering a customized “page saved” results web page (Flows 1112 and 1113 and Step 1380).

To allow a user may retrieve any saved browser state information, environment 100 may provide a “retrieve saved data” web service content button on all web pages provided by content web server 125 following a successful save process. For example, if the user did not end a user session when saving browser sate information, a subsequently invoked web service may include code that provides a retrieval button that includes HTML code for setting the WSID hidden field to STASH and the PC hidden field to “RETRIEVE” (reflecting a function performed by the STASH web service for retrieving saved field information from stash database 1130). If the user session was ended during or following a successful save process, authentication web service WS AUTH may be configured to provide the “retrieve saved data” content button on a web page displayed to a user following a successful log in. Accordingly, harness 300 invokes the STASH web service based on field information provided by client system 110-1 when the user activates the “retrieve saved data” content button. The STASH web service retrieves the saved field information from database 1130 based on the post command field being set at “RETRIEVE” and provides the retrieved information to harness 300. Using the retrieved field information and any XML content data included in the saved field information (e.g., format tags, etc.), harness 300 generates web components for web content server 125. The web components allow content web server 125 to regenerate the exact HTML content that was displayed to the user when the browser state information was previously saved by environment 100.

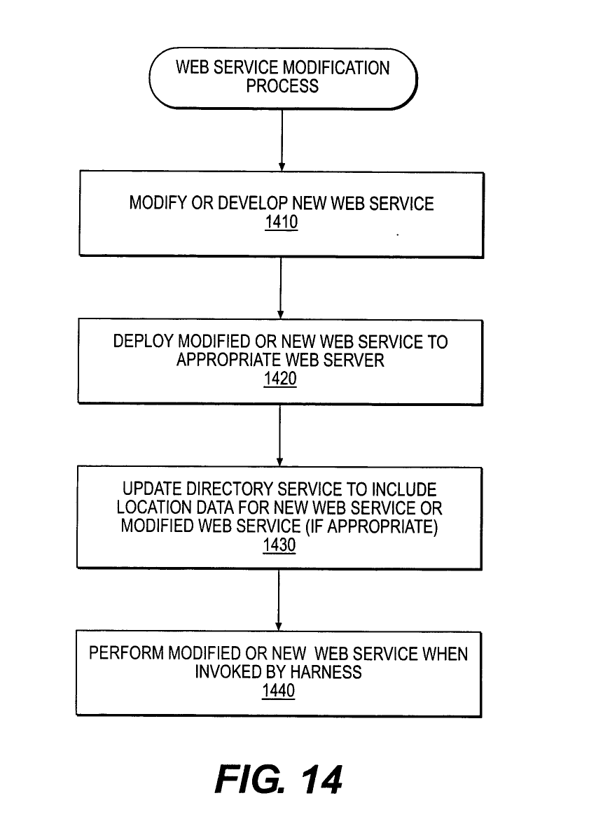

In another embodiment of the invention, environment 100 allows a developer to dynamically and seamlessly integrate a modified or new web service into a web service enterprise without requiring programming at the harness 300 or any other consumer of the modified or new web service. Instead, the only programming that may be required is associated with developing or modifying the web service and perhaps updating directory service 130. FIG. 14 shows a flowchart of an exemplary web service modification process consistent with embodiments of the present invention. At step 1410, a developer may modify, or develop a new, web service by programming the service using known web service development software techniques. Once modified or created, the developer deploys the web service to the appropriate web server that performs the service (Step 1420). This may include integrating a new web server into environment 100 or deploying the web service to an existing web server. If appropriate, the developer or administrator may update the data structure stored in directory service 130 to associate authorized users with the new or modified web service (Step 1430). If a new web service is deployed on a new web server, the URL for that service is also added to the data structure in directory service 130. Once deployed, the modified or new web service is ready to be invoked by harness 300 during any authorized user session (step 1440). Accordingly, because harness 300 does not generate proxy objects for web services WS1 to WSX, it may invoke a modified web service as it is redeployed by executing the same generic interface (e.g., VDP Talk) used to access all other web services.

In addition to allowing a developer to easily modify business functions performed by a web service, embodiments of the present invention enable the developer to modify non-business functions associated with a web service's result data, such as text, format data, etc. To modify this type of information, the developer may modify the XML data stored in XML content database 150. For example, the developer may add new, or modify existing, XML tags in an XML description document associated with a web service. Accordingly, when the web service retrieves the XML content data from XML content database 150, the modified or new XML tags are automatically included in the XML data stream provided to harness 300. Consequently, the user is provided with HTML content that includes the modified, or new, format data associated with the changed XML tags without requiring any programming in harness 300, the client system operated by the user, or the web service being invoked.

As described, methods, systems, and articles of manufacture consistent with embodiments of the present invention enable an environment to dynamically configure a web service enterprise for an authorized user using a virtual distribution portal (e.g., harness 300). Because harness 300 is configured without web service business logic, a developer may update the web service enterprise without having to reprogram code included in consumers of the modified web services. Although embodiments of the present invention have been described with reference to the features of exemplary system environment 100 of FIG. 1, one skilled in the art can appreciate that various other configurations may be employed. For example, instead of using web components, such as ASP.Net web components, harness 300 may be configured to convert the XML content data received from a web service directly to HTML using software based on the JAVA® programming language provided by Sun Microsystems, Inc.

In another embodiment, harness 300 establishes and manages multiple web service enterprises for corresponding multiple users. For example, harness 300 may store multiple temporary session directory maps for each authorized user and invokes corresponding web services as they are requested by the users.

In yet another embodiment of the invention, environment 100 may include one or more generic web services, such as the STASH and authentication web services, that are authorized for every user listed in directory service 130. These generic web services may perform generic business functions that may be used with, or without, a currently invoked web service that perform specific business functions, such as obtaining an insurance rate quote. Accordingly, any authorized user may access these generic web services to perform administrative functions, such as saving session data, retrieving saved session data, etc.

Additionally, embodiments of the present invention allow environment 100 to determine when a web service request exceeds a predetermined service level (e.g., a time limit, such as forty-five seconds) and generates an error message that is displayed at the client system. The error information is stored in an XML log file and triggers a time out web service that is configured to notify a user (e.g., administrator) of the error using various mediums, such as electronic mail, paging media, telephonic voice messaging media, etc.

Further, embodiments of the present invention allow a developer to deploy multiple versions of a web service to allow the developer to update one version of the same web service while the older version is in use. Once the updated copy of the web service is validated, the modified service may be made available to users through harness 300 using the various features of the present invention.

Other embodiments of the invention will be apparent to those skilled in the art from consideration of the specification and practice of the exemplary embodiments of the invention disclosed herein. For example, the process and sequence of steps shown in FIGS. 5-14 are not limited to the sequence described therein. Variations of these sequences, such as the reordering, removal and/or the addition of other steps may be implemented without departing from the scope of the embodiments of the present invention.

Although embodiments of the present invention are described as being associated with data stored in memory and other storage mediums, one skilled in the art can appreciate that these aspects can also be stored on or read from other types of computer-readable media, such as secondary storage devices, including: hard disks, floppy disks, or CD-ROM; a carrier wave from the Internet; or other forms of RAM or ROM. Accordingly, the specification is intended to be exemplary and the invention is not limited to the above described embodiments. Instead, the present invention is defined by the appended claims and their full scope of equivalents.

1. A method for providing a web service to a user, comprising:
determining a set of web services the user is authorized to access based on a user profile;
receiving a request by the user to invoke a web service from the set of authorized web services;
locating the web service using a first data value included in a set of data values that are defined based on the user request;
invoking the located web service using a generic interface that is capable of invoking at least one other web service;
generating result data by the web service based on a second data value included in the set of data values;
generating result content from the result data; and
displaying the result content to the user.

2. The method of claim 1, wherein determining a set of web services includes:
invoking an authentication web service that retrieves the set of authorized web services from a directory service based on the user profile; and
creating a session directory map including an identifier and location data for each of the authorized web services, wherein the session directory map is temporarily stored in a memory for a duration of a user session between the authorized user and a distribution server.

3. The method of claim 2, wherein invoking the authentication web service includes:
identifying the authentication web service based on a data field value corresponding to the authentication web service that is set by the distribution server when the user attempts to establish the user session.

4. The method of claim 1, wherein receiving a request by the user to invoke the web service includes:
displaying a web page including web service content corresponding to the web service;
receiving, from the user, a selection of the web service content included in the web page; and
setting the first data value to reflect an identifier corresponding to the web service and the second data value to reflect a function that is performed by the web service based on the user selection.

5. The method of claim 4, wherein the first and second data values are associated with a first and second hidden field, respectively, that are included in the web page.

6. The method of claim 5, wherein receiving, from the user, a selection of the web service content included in the web page includes:
receiving a third data value from the user.

7. The method of claim 6, wherein receiving a request by the user to invoke a web service includes:
providing the first hidden field, the second hidden field, and the third data value to a distribution server that is configured to invoke any of the authorized web services.

8. The method of claim 2, wherein locating the web service includes:
matching the identifier for the web service with a corresponding identifier included in the session directory map; and
retrieving the location data for the web service from the session directory map based on the matching.

9. The method of claim 8, wherein invoking the web service includes:
executing the generic interface at the distribution server to access the web service using the location data for the web service, wherein the generic interface establishes a communication session between the distribution server and the web service.

10. The method of claim 9, wherein invoking the web service further includes:
creating a first field array including identification data corresponding to the first and second data values and a second field array including the first and second data values; and
providing the first and second field arrays to the web service during the communication session.

11. The method of claim 1, wherein the second data value reflects a function that is performed by the web service and generating result data includes:
performing the function reflected by the second data value to generate the result data.

12. The method of claim 1, wherein the second data value reflects a function that is performed by the web service and generating result data includes:
performing the function reflected by the second data value using a third data value that is provided by the user during the receiving step to produce the result data.

13. The method of claim 1, wherein generating result data includes:
retrieving, by the web service, format data from a database corresponding to display characteristics associated with the user profile and result data.

14. The method of claim 13, wherein generating result content includes:
generating the result content from the result data and the format data.

15. The method of claim 13, wherein generating result content includes:
receiving at a distribution server the result data and format data from the web service;
generating web components from the result data and format data;
generating, at a content server, the result content from the web components.

16. The method of claim 1, wherein the result content includes a result web page that includes the result data and is custom formatted based on the user profile.

17. The method of claim 1, wherein the result content includes web service content corresponding to a second web service included in the set of authorized web services, and wherein the method includes:
repeating the steps of receiving, locating, invoking, generating result data, generating result content, and displaying for the second web service.

18. A method for distributing content to a user in a distributed web service environment including a distribution server, a client system operated by a user, and web services including an authentication web service, the method comprising:
receiving a request by the user to access the distribution server;
invoking the authentication web service using an identifier and location data corresponding to the authentication web service included in the directory service;
authenticating the user based on user information included in the request;
retrieving session tags associated with the authenticated user from a directory service, wherein the session tags identify, for the user, a set of authorized web services and their corresponding location in the environment;
generating, at the distribution server, a session directory map using the session tags, wherein the session directory map is temporarily stored in the distribution server during a user session between the authenticated user and the distribution server; and
providing a web page to the client system including content corresponding to at least one of the authorized web services that, when selected by the user, initiates a request to invoke the at least one of the authorized web services.

19. A method for saving current state information in an environment including a client system operated by a user and a distribution server that manages access to web services including a host web service that has been invoked by the distribution server and is executing a process for the user during a user session between the distribution server and the client system, wherein the client system includes a browser that displays a web page including a set of data fields corresponding to the host web service, the method comprising:
receiving a request to save the current state of the user's browser during the user session;
setting as a function of the request, a first hidden field to identify a storage web service, a second hidden field to identify a save function to be performed by the storage web service, and a third hidden field to identify the host web service;
providing the first, second, and third hidden fields, and the set of data fields, from the client system to the distribution server;
invoking the storage web service using the first hidden field and a generic interface that is used by the distribution server to invoke any of the web services;
storing, by the storage web service, data fields and hidden fields in a database as a single stream of XML data; and
generating result content indicating that the browser state information is successfully saved.

20. The method of claim 19, further including:
setting by the storage web service a redirect tag in the XML data stream to identify the host web service using the third hidden field;
providing the XML data stream to the distribution server;
redirecting the XML data stream to the host web service based on the redirect tag;
determining, at the host web service, that the save function is being performed based on the second hidden field;
retrieving XML content data corresponding to the save function from a second database;
generating, at the distribution server, web components from the XML content data; and
generating the result content from the web components.

21. The method of claim 19, wherein the request to save the current state of the user's browser is provided by one of the user and a process that automatically provides the request.

22. The method of claim 19, further including:
receiving a second request to retrieve the saved state information;
setting, based on the second request, the first hidden field to identify the storage web service and the second hidden field to identify a retrieve function to be performed by the storage web service;
providing the first and second hidden fields from the client system to the distribution server;
invoking the storage web service using the first hidden field and the generic interface;
retrieving, by the storage web service, the XML data stream stored in the database;
generating retrieved content from the XML data stream; and
generating, at the client system, the web page including the set of data fields from the retrieved content.

23. The method of claim 19, wherein the set of data fields includes data fields that each include one or more data values provided by the user during the user session.

24. A method of dynamically provisioning a web service enterprise, comprising:
receiving a request to invoke a web service from an authorized user;
executing a generic interface to locate and invoke the web service to produce result data, wherein the generic interface capable of invoking other web services included in the web service enterprise; and
providing the result data to the user.

25. A method for dynamically establishing a web service enterprise in a distributed system during a user session between a distribution server and a client system operated by the user, the method comprising:
determining during the user session any web services that the user is authorized to access based on a user profile;
creating a temporary session directory identifying the authorized web services and their location in the distributed system;
managing an exchange of data between the client system and the authorized web services during the user session such that web services are invoked using a common preprogrammed interface to produce result data that is displayed at the client system in customized content rendered based on the user profile; and
removing the temporary session directory when the user session ends.

26. A method for providing a web service enterprise, comprising:
authenticating a user;
creating an associative structure noting associations between identifiers for any web services the user is authorized to use and location information for identified web services;
generating, at a client system operated by the user, a web page including content associated with the web service;
receiving, from the user, a request to invoke the web service through the content;
setting a first hidden field identifying the web service and a second hidden field indicating a type of function to be performed by the web service based on the user selecting the content in the web page;
locating, at a distribution server, the web service using the first hidden field and the location information in the associative structure;
providing, from the distribution server, at least one field array to the located web service using a generic interface that is used to invoke other web services that the user is authorized to access, wherein the at least one field array includes the first and second hidden fields;
producing result data at the web service based on the second hidden field;
retrieving from a database format content corresponding to the result data and user profile information;
providing the format content and result data to the distribution server;
generating result content using the provided format content and result data; and
generating a customized result web page at the client system based on the result content.

27. A method for modifying a web service in a distributed system including a distribution server that invokes an existing web service using a generic interface in response to a invocation request from an authorized user during a user session between the user and the distribution server, the method comprising:
modifying the existing web service;
deploying the modified web service on a web server; and
updating a directory service with information reflecting an identifier of the modified web service and a relationship including (i) a location of the web service in the distributed system and (ii) the authorized user,
wherein the distribution server uses the information to locate and invoke the modified web service using the same generic interface used to invoke the existing web service before its modification.

28. The method of claim 27, wherein modifying the web service is performed during or prior to the user session.

29. The method of claim 28, wherein the distribution server receives the information from an authentication web service that retrieves the information in response to a successful authentication of the authorized user.

30. A method for deploying a new a web service in a distributed system including a distribution server that invokes at least one existing web service through a generic interface in response to a invocation request from an authorized user during a user session between the user and the distribution server, the method comprising:
creating the new web service;
deploying the new web service on a web server; and
updating a directory service with information reflecting an association between an identifier of the new web service and (i) a location of the web service in the distributed system and (ii) the authorized user,
wherein the distribution server uses the information to locate and invoke the new web service using the same generic interface used to invoke the at least one existing web service.

31. A system for creating a web service enterprise, comprising:
a client system operated by an authorized user;
a directory service including map information reflecting an association between the authorized user and a first web service;
a plurality of web services including the first web service and an authentication web service; and
a distribution server configured to invoke the authentication web service using a preprogrammed interface to authenticate the user and receive the map information from the authentication web service when the user is authenticated to create a temporary session directory map, wherein the distribution server uses the temporary session directory map to locate and invoke the first web service based on an invocation request from the user received by the client system.

32. A system for dynamically providing a web service enterprise including web services, comprising:
a client system operated by an authorized user; and
a distribution server configured to provide content information used by the client system to generate a customized web page for the authorized user based on a user profile, wherein the customized custom web page includes web service content corresponding to a web service that the authorized user is allowed to access and one or more hidden fields that are set with data values in response to the user selecting the web service content in the customized web page,
wherein the content information is based on web service information received from the web service when invoked by the distribution server using a preprogrammed interface in response to the user selection, and wherein the distribution server uses the preprogrammed interface to locate and invoke other web services included in the enterprise.

33. A system for dynamically providing web services to a user, comprising:
a plurality of servers each implementing one or more web services that perform one or more processes that produce corresponding result data;
a client system operated by a user including software that, when executed by a processor, sets data values to one or more hidden fields and a user data field associated with an authorized web service included in the one or more web services based on input received by the user; and
a distribution server configured to:
receive the one or more hidden fields and a user defined data field from the client system,
generate a temporary directory map identifying the authorized web service and its location in the system based on a user profile during a user session between the client system and the distribution server, wherein the distribution server is configured to remove the temporary directory map when the user session ends,
provide the hidden data fields and user data field to the authorized web service using a preprogrammed interface that is used to invoke any of the one or more web services, and
receive result data generated by the authorized web service using the at least one of the hidden data fields and the user data field, and generate content information based on the result data that is used to by the client system to provide the client side content.

34. A system for dynamically providing web services, comprising:
a client system; and
a computing system configured to dynamically configure a web service enterprise for an authorized user including a web service that the authorized user is allowed to access, wherein the computing system manages the exchange of data between the web service and the client system using a preprogrammed interface that is configured to establish a communication session with any of the web services, wherein the data includes request data provided by the client system in response to an invocation request by the user and result data generated by a web service included in the set of web services in response to the invocation request provided by the user.

35. A computer-readable medium including instructions for performing a method, when executed by a processor, for providing a web service to a user, the method comprising:
determining a set of web services the user is authorized to access based on a user profile;
receiving a request by the user to invoke a web service from the set of authorized web services;
locating the web service using a first data value included in a set of data values that are defined based on the user request;
invoking the located web service using a generic interface that is capable of invoking at least one other web service;
generating result data by the web service based on a second data value included in the set of data values;
generating result content from the result data; and
displaying the result content to the user.

36. A computer-readable medium including instructions for performing, when executed by a processor, a method for distributing content to a user in a distributed web service environment including a distribution server, a client system operated by a user, and web services including an authentication web service,.the method comprising:
receiving a request by the user to access the distribution server;
invoking the authentication web service using an identifier and location data corresponding to the authentication web service included in the directory service;
authenticating the user based on user information included in the request;
retrieving session tags associated with the authenticated user from a directory service, wherein the session tags identify, for the user, a set of authorized web services and their corresponding location in the environment;
generating, at the distribution server, a session directory map using the session tags, wherein the session directory map is temporarily stored in the distribution server during a user session between the authenticated user and the distribution server; and
providing a web page to the client system including content corresponding to at least one of the authorized web services that, when selected by the user, initiates a request to invoke the at least one of the authorized web services.

37. A computer-readable medium including instructions for performing, when executed by a processor, a method for saving current state information in an environment including a client system operated by a user and a distribution server that manages access to web services including a host web service that has been invoked by the distribution server and is executing a process for the user during a user session between the distribution server and the client system, wherein the client system includes a browser that displays a web page including a set of data fields corresponding to the host web service, the method comprising:
receiving a request to save the current state of the user's browser during the user session;
setting as a function of the request, a first hidden field to identify a storage web service, a second hidden field to identify a save function to be performed by the storage web service, and a third hidden field to identify the host web service;
providing the first, second, and third hidden fields, and the set of data fields, from the client system to the distribution server;
invoking the storage web service using the first hidden field and a generic interface that is used by the distribution server to invoke any of the web services;
storing, by the storage web service, data fields and hidden fields in a database as a single stream of XML data; and
generating result content indicating that the browser state information is successfully saved.

38. A computer-readable medium including instructions for performing, when executed by a processor, a method of dynamically provisioning a web service enterprise, the method comprising:
receiving a request to invoke a web service from an authorized user;
executing a generic interface to locate and invoke the web service to produce result data, wherein the generic interface capable of invoking other web services included in the web service enterprise; and
providing the result data to the user.

39. A computer-readable medium including instructions for performing, when executed by a processor, a method for dynamically establishing a web service enterprise in a distributed system during a user session between a distribution server and a client system operated by the user, the method comprising:
determining during the user session any web services that the user is authorized to access based on a user profile;
creating a temporary session directory identifying the authorized web services and their location in the distributed system;
managing an exchange of data between the client system and the authorized web services during the user session such that web services are invoked using a common preprogrammed interface to produce result data that is displayed at the client system in customized content rendered based on the user profile; and
removing the temporary session directory when the user session ends.

40. A computer-readable medium including instructions for performing, when executed by a processor, a method for providing a web service enterprise, the method comprising:
authenticating a user;
creating an associative structure noting associations between identifiers for any web services the user is authorized to use and location information for identified web services;
generating, at a client system operated by the user, a web page including content associated with the web service;
receiving, from the user, a request to invoke the web service through the content;
setting a first hidden field identifying the web service and a second hidden field indicating a type of function to be performed by the web service based on the user selecting the content in the web page;
locating, at a distribution server, the web service using the first hidden field and the location information in the associative structure;
providing, from the distribution server, at least one field array to the located web service using a generic interface that is used to invoke other web services that the user is authorized to access, wherein the at least one field array includes the first and second hidden fields;
producing result data at the web service based on the second hidden field;
retrieving from a database format content corresponding to the result data and user profile information;
providing the format content and result data to the distribution server;
generating result content using the provided format content and result data; and
generating a customized result web page at the client system based on the result content.

41. A computer-readable medium including instructions for performing, when executed by a processor, a method for modifying a web service in a distributed system including a distribution server that invokes an existing web service using a generic interface in response to a invocation request from an authorized user during a user session between the user and the distribution server, the method comprising:
modifying the existing web service;
deploying the modified web service on a web server; and
updating a directory service with information reflecting an identifier of the modified web service and a relationship including (i) a location of the web service in the distributed system and (ii) the authorized user,
wherein the distribution server uses the information to locate and invoke the modified web service using the same generic interface used to invoke the existing web service before its modification.

42. A computer-readable medium including instructions for performing, when executed by a processor, a method for deploying a new a web service in a distributed system including a distribution server that invokes at least one existing web service through a generic interface in response to a invocation request from an authorized user during a user session between the user and the distribution server, the method comprising:
creating the new web service;
deploying the new web service on a web server; and
updating a directory service with information reflecting an association between an identifier of the new web service and (i) a location of the web service in the distributed system and (ii) the authorized user,
wherein the distribution server uses the information to locate and invoke the new web service using the same generic interface used to invoke the at least one existing web service.

43. A system for providing a web service to a user, comprising:
means for determining a set of web services the user is authorized to access based on a user profile;
means for receiving a request by the user to invoke a web service from the set of authorized web services;
means for locating the web service using a first data value included in a set of data values that are defined based on the user request;
means for invoking the located web service using a generic interface that is capable of invoking at least one other web service;
means for generating result data by the web service based on a second data value included in the set of data values;
means for generating result content from the result data; and
means for displaying the result content to the user.

44. A system for distributing content to a user in a distributed web service environment including a distribution server, a client system operated by a user, and web services including an authentication web service, the system comprising:
means for receiving a request by the user to access the distribution server;
means for invoking the authentication web service using an identifier and location data corresponding to the authentication web service included in the directory service;
means for authenticating the user based on user information included in the request;
means for retrieving session tags associated with the authenticated user from a directory service, wherein the session tags identify, for the user, a set of authorized web services and their corresponding location in the environment;
means for generating, at the distribution server, a session directory map using the session tags, wherein the session directory map is temporarily stored in the distribution server during a user session between the authenticated user and the distribution server; and
means for providing a web page to the client system including content corresponding to at least one of the authorized web services that, when selected by the user, initiates a request to invoke the at least one of the authorized web services.

45. A system for saving current state information in an environment including a client system operated by a user and a distribution server that manages access to web services including a host web service that has been invoked by the distribution server and is executing a process for the user during a user session between the distribution server and the client system, wherein the client system includes a browser that displays a web page including a set of data fields corresponding to the host web service, the system comprising:
means for receiving a request to save the current state of the user's browser during the user session;
means for setting as a function of the request, a first hidden field to identify a storage web service, a second hidden field to identify a save function to be performed by the storage web service, and a third hidden field to identify the host web service;
means for providing the first, second, and third hidden fields, and the set of data fields, from the client system to the distribution server;
means for invoking the storage web service using the first hidden field and a generic interface that is used by the distribution server to invoke any of the web services;
means for storing, by the storage web service, data fields and hidden fields in a database as a single stream of XML data; and
means for generating result content indicating that the browser state information is successfully saved.

46. A system for dynamically provisioning a web service enterprise, comprising:
means for receiving a request to invoke a web service from an authorized user;
means for executing a generic interface to locate and invoke the web service to produce result data, wherein the generic interface capable of invoking other web services included in the web service enterprise; and
means for providing the result data to the user.

47. A system for dynamically establishing a web service enterprise in a distributed system during a user session between a distribution server and a client system operated by the user, the system comprising:
means for determining during the user session any web services that the user is authorized to access based on a user profile;
means for creating a temporary session directory identifying the authorized web services and their location in the distributed system;
means for managing an exchange of data between the client system and the authorized web services during the user session such that web services are invoked using a common preprogrammed interface to produce result data that is displayed at the client system in customized content rendered based on the user profile; and
means for removing the temporary session directory when the user session ends.

48. A system for providing a web service enterprise, comprising:
means for authenticating a user;
means for creating an associative structure noting associations between identifiers for any web services the user is authorized to use and location information for identified web services;
means for generating, at a client system operated by the user, a web page including content associated with the web service;
means for receiving, from the user, a request to invoke the web service through the content;
means for setting a first hidden field identifying the web service and a second hidden field indicating a type of function to be performed by the web service based on the user selecting the content in the web page;
means for locating, at a distribution server, the web service using the first hidden field and the location information in the associative structure;
means for providing, from the distribution server, at least one field array to the located web service using a generic interface that is used to invoke other web services that the user is authorized to access, wherein the at least one field array includes the first and second hidden fields;
means for producing result data at the web service based on the second hidden field;
means for retrieving from a database format content corresponding to the result data and user profile information;
means for providing the format content and result data to the distribution server;
means for generating result content using the provided format content and result data; and
means for generating a customized result web page at the client system based on the result content.

49. A system for modifying a web service in a distributed system including a distribution server that invokes an existing web service using a generic interface in response to a invocation request from an authorized user during a user session between the user and the distribution server, the system comprising:
means for modifying the existing web service;
means for deploying the modified web service on a web server; and
means for updating a directory service with information reflecting an identifier of the modified web service and a relationship including (i) a location of the web service in the distributed system and (ii) the authorized user,
means for wherein the distribution server uses the information to locate and invoke the modified web service using the same generic interface used to invoke the existing web service before its modification.

50. A system for deploying a new a web service in a distributed system including a distribution server that invokes at least one existing web service through a generic interface in response to a invocation request from an authorized user during a user session between the user and the distribution server, the method comprising:
means for creating the new web service;
means for deploying the new web service on a web server; and
means for updating a directory service with information reflecting an association between an identifier of the new web service and (i) a location of the web service in the distributed system and (ii) the authorized user,
wherein the distribution server uses the information to locate and invoke the new web service using the same generic interface used to invoke the at least one existing web service.
